(19) United States
(12) Patent Application Publication
(10) Pub. No.: US 2012/0082405 A1
(43) Pub. Date: Apr. 5, 2012

(54) Drawstring Polymeric Bag

(75) Inventors: Michael A. Ross, Dallas, TX (US); George M. Hall, Colleyville, TX (US)

(73) Assignee: POLY-AMERICA, L.P., Grand Prairie, TX (US)

(21) Appl. No.: 12/897,031

(22) Filed: Oct. 4, 2010

(51) Int. Cl. B65D 33/28; B31B 1/00

(52) U.S. Cl. 383/75; 493/267

(57) ABSTRACT

The present invention is directed to a drawstring trash bag having drawstring access holes with increased width and a method for producing drawstring trash bags having drawstring access holes with increased widths.

### CROSS-REFERENCE TO RELATED APPLICATIONS

Not applicable.

### BACKGROUND OF THE INVENTION

1. Field of the Invention

The present invention relates to improvements in the construction and manufacture of polymeric bags. In particular, the present invention relates to improvements to drawstring-type polymeric bags, especially polymeric trash bags.

2. Description of the Related Art

Polymeric bags are ubiquitous in modern society. Such bags are available in a countless number of combinations of capacities, thicknesses, dimensions and colors. Polymeric bags may be used in numerous ways including for long-term storage, food storage and trash collection. In response to consumer demand, manufacturers of polymeric bags have also developed several innovations over the years to improve the utility and performance of polymeric bags. The present invention is of particular interest to the use of polymeric bags for trash collection and with respect to the methods for accessing the closure and for securely closing such trash bags.

While the polymeric trash bags available to consumers are available in a variety of different configurations, certain configurations are designed to cater to certain uses and particular segments of the population. When considering the utility of polymeric trash bags, one issue of primary concern to both consumers and manufacturers is how the consumer can securely close and carry the trash bag after filling it with debris. Securing the trash bag is of critical importance to containing the trash and other debris inside the trash bag when it is collected and transported. Over the years, the industry has developed several different methods for securely closing and carrying trash bags, each method having certain advantages and disadvantages over the other methods.

Trash bags with drawstring closures are a popular consumer product. As the name suggests, drawstring bags utilize a drawstring, also known as a drawtape, which is incorporated into the bag design. Drawstrings are typically enclosed within the hems running along the upper opening of the bag. To minimize the possibility of puncture or tear during use, the drawstrings are usually stronger than the material used to construct the bag. To close the bag, the central portions of the drawstrings are pulled vertically through the small drawstring access holes in the hems, thereby pulling the opposing upper corners of the bag together. The drawstrings can then be tied together, securing the contents of the bag and allowing the drawstring bag and its contents to be hauled away. The demand for new and improved drawstrings, and new and improved drawstring bags, is the driving force behind the innovation of the present invention.

One problem of significant concern when using drawstring trash bags is the frequent difficulty in accessing and gripping the drawstring itself. The drawstring trash bags known in the prior art have relatively narrow drawstring access holes making accessing and gripping of such drawstrings difficult. Specifically, the drawstrings of the prior art are typically 1 inch in height while the drawstring access holes are never more than 2 inches in width and less than 1 inch in height. Therefore, the area available to access and grip the drawstring via the drawstring access hole is less than 1.6 square inches. This relatively small surface area can make gripping the drawstring difficult in numerous situations, such as when the dexterity of a person's fingers is limited by gloves or other clothing or when the person does not have complete visibility of the bag but is trying to feel his or her way to the drawstring. Moreover, this gripping problem is further complicated by other conditions that may be present.

The gripping problem is further exacerbated in the context of lawn and leaf bags and other drawstring bags intended to contain bulky or heavy material. Such bags are commonly used for the collection and disposal of yard waste such as grass clippings, fallen leaves, and other bulky debris. As a person collects yard waste or works on outdoor projects, it is common for the person to wear outdoor yard gloves to protect one's hands from dirt and other matter which may irritate the skin. However, outdoor yard gloves can also negatively affect the dexterity of a person's fingers when the gloves are worn, making it difficult to access and grasp the drawstrings, which may have a smooth, slippery surface. Additionally, the presence of oils, dirt, and other contaminants accumulating on the surfaces of the gloves and the drawstrings can make gripping even more difficult.

In view of the foregoing, it would be desirable to provide a drawstring trash bag which features a drawstring that is easier to access and grasp. This would be particularly advantageous in situations where gripping a drawstring may be complicated due to the use of gloves or the presence of contaminants which make the drawstring slippery. Therefore, a need exists for a polyethylene drawstring trash bag wherein the drawstring is more easily grasped during use. The present invention addresses this and other needs.

### SUMMARY OF THE INVENTION

One aspect of the present invention is to provide a drawstring trash bag. The drawstring trash bag comprises a first panel and a second panel. The first panel and second panel are joined along a first side edge, a second side edge, and a bottom edge. A first drawstring is disposed within a first hem in the first panel. Additionally, a first drawstring access hole is provided in the first panel wherein the first drawstring access hole has a width and a height. Moreover, the width of the first drawstring access hole is at least two times the height of the first drawstring access hole.

In some embodiments of the present invention, a second drawstring may be disposed within a second hem in the second panel. Additionally, a second drawstring access hole is provided in the second panel wherein the second drawstring access hole has a width and a height. Moreover, the width of the second drawstring access hole is at least two times the height of the second drawstring access hole.

In certain embodiments of the present invention, the first drawstring, the second drawstring, or both drawstrings may be embossed drawstrings. In some embodiments, the first drawstring access hole, the second drawstring access hole, or both drawstring access holes may be substantially elliptical. In some specific embodiments, the width of the first drawstring access hole may be between two and four times the height of the first drawstring access hole. Additionally, in certain preferred embodiments, the width of the first drawstring access hole may be approximately three times the height of the first drawstring access hole. In other embodiments, the width of the second drawstring access hole may be between two and four times the height of the second drawstring access hole with the width of the second drawstring access hole being approximately three times the height of the second drawstring access hole in some preferred embodiments.

It is contemplated that the present invention may be utilized in ways that are not fully described or set forth herein. The present invention is intended to encompass these additional uses to the extent such uses are not contradicted by the appended claims. Therefore, the present invention should be given the broadest reasonable interpretation in view of the present disclosure, the accompanying figures, and the appended claim.

### BRIEF DESCRIPTION OF THE RELATED DRAWINGS

A full and complete understanding of the present invention may be obtained by reference to the detailed description of the present invention and certain embodiments when viewed with reference to the accompanying drawings. The drawings can be briefly described as follows.

FIG. 1 provides an elevation view of a drawstring trash bag according to one embodiment of the present invention.

FIG. 2 provides an elevation view of a panel of a drawstring trash bag according to one embodiment of the present invention.

FIG. 3 provides an overhead elevation view of the process for producing a certain embodiment of the present invention.

FIG. 4 provides an elevation view of a panel of a drawstring trash bag according to one embodiment of the present invention.

### DETAILED DESCRIPTION OF THE INVENTION

The present disclosure illustrates several embodiments of the present invention. It is not intended to provide an illustration or encompass all embodiments contemplated by the present invention. In view of the disclosure of the present invention contained herein, a person having ordinary skill in the art will recognize that innumerable modifications and insubstantial changes may be incorporated or otherwise included within the present invention without diverging from the spirit of the invention. Therefore, it is understood that the present invention is not limited to those embodiments disclosed herein. The appended claims are intended to more fully and accurately encompass the invention to the fullest extent possible, but it is fully appreciated that certain limitations on the use of particular terms is not intended to conclusively limit the scope of protection.

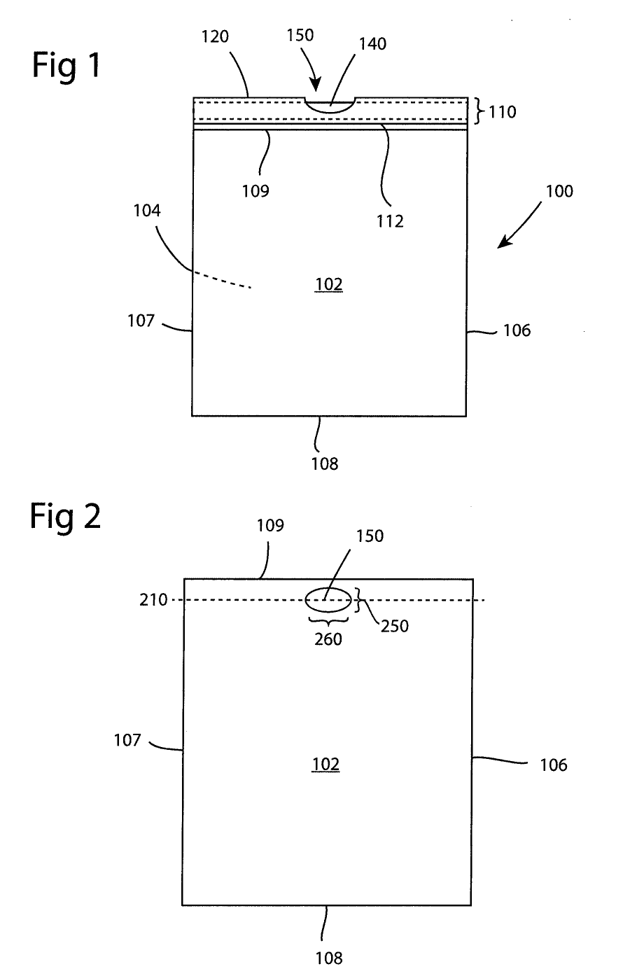

Referring initially to FIG. 1, an elevation view of a drawstring trash bag 100 is shown. The drawstring trash bag 100 comprises a first panel 102 and a second panel 104 located behind the first panel 102. The first panel 102 and the second panel 104 are joined along a first side edge 106, a second side edge 107, and a bottom edge 108. In a typical embodiment, the respective top edges 109 of both the first panel 102 and the second panel 104 are folded down to form the respective hems 110 in each panel 102 and 104 with hem seals 112 defining the bottom of the respective hems 110.

Still referring to FIG. 1, drawstrings 140 are disposed within the respective hems 110 of the first and second panel 102 and 104. The drawstrings 140 extend substantially the width of the drawstring trash bag 100 and are anchored at or near the first and second side edges 106 and 107 respectively. In order to access the drawstring 140 from the outside of the bag, a drawstring access hole 150 is provided along the bag opening 120 and in the hems 110 of the first and second panel 102 and 104. It is further contemplated that in certain embodiments the drawstrings 140, the panels 102 and 104, or some combination thereof may be embossed with one or more patterns. The drawstring access hole 150 of a preferred embodiment is described in more detail with respect to FIG. 2.

FIG. 2 provides an elevation view of a first panel 102 of a preferred embodiment of the present invention. The first panel 102 has a first side edge 106, a second side edge 107, a bottom edge 108, and a top edge 109. The panel 102 is shown in an unfolded configuration after the drawstring access hole 150 has been formed but before insertion of the drawstring 140 and formation of the hems 110 which will be formed by folding the top edge 109 of panel 102 along line 210 which approximately bisects the drawstring access hole 150. The drawstring 140 is typically sized to extend across the width of the bag 100 but is selected to be slightly shorter in height than the hem 110 enclosing the drawstring 140.

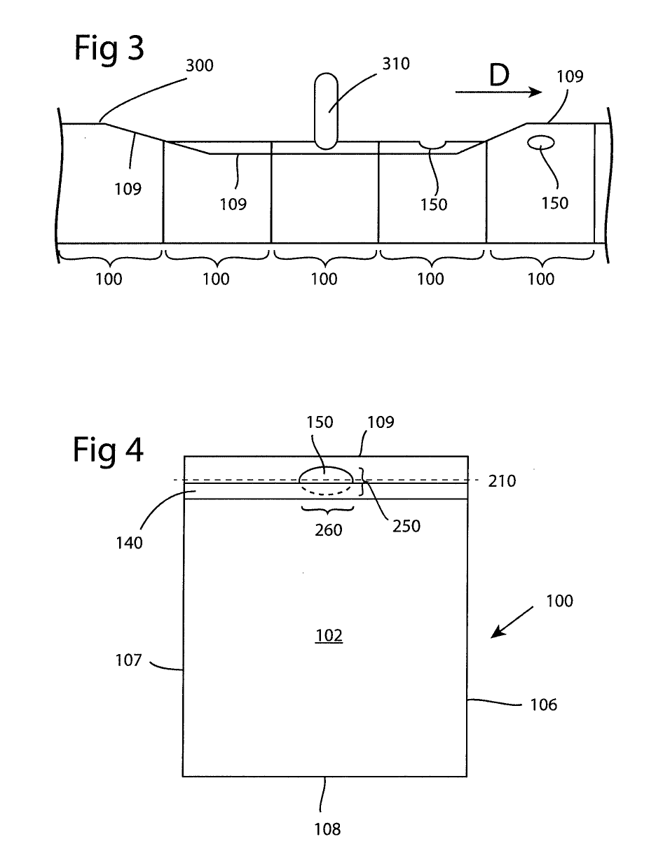

Typically, the drawstring access hole 150 of the present invention may be formed using a type of punch-out apparatus described in more detail with respect to FIG. 3. The drawstring access hole 150 of the present invention is generally defined to have a height 250, measured in the same direction that the side edges 106 and 107 of the bag 100 run, and a width 260, measured in generally the same direction as the top edge 109 and bottom edge 109 of the bag 100. Balancing various manufacturing challenges with the subjective preferences of trash bag users, it has been found that the drawstring access hole 150 enhances the ability of a user to grasp a trash bag when the width 260 of the drawstring access hole 150 is at least twice the height 250 of the drawstring access hole 150. Moreover, in preferred embodiments of the present invention, the width 260 is generally between two and four times the height 250. Additionally, in certain embodiments of the present invention, the drawstring access hole 150 can be substantially elliptical in shape.

FIG. 3 depicts an overhead elevation view of a method for manufacturing the present invention. A web of material 300, which will be converted into a plurality of drawstring trash bags 100, travels in direction D. As the web of material 300 travels in direction D, the top edge 109 of the web of material 300 is folded down prior to formation of the drawstring access hole 150. A portion of the web of material 300 is removed by a drawstring access hole punching device 310 to create the drawstring access holes 150. A person of ordinary skill in the art would understand that various types of drawstring access hole punching devices 310 may be utilized including punching devices that use a high speed rotating knife or an anvil in combination with an appropriate matching cutting blade. After creating the drawstring access hole 150 the web of material 300 can be unfolded to provide the panel depicted in FIG. 2. Subsequently a drawstring 140 may be placed on the panel as shown in FIG. 4.

Referring now to FIG. 4, a panel 102 is again shown which is substantially identical to the panel disclosed in FIG. 2 except for the inclusion of the drawstring 140 to better illustrates the relation of the drawstring 140 to the drawstring access hole 150 prior to folding the top edge 109 of the panel 102 along line 210 and the subsequent formation of the hems 110. In particular, the drawstring 140 covers approximately half of the drawstring access hole 150 prior to folding the top edge 109 over to form the hems 110.

As previously noted, the specific embodiments depicted herein are not intended to limit the scope of the present invention. Indeed, it is contemplated that any number of different embodiments may be utilized without diverging from the spirit of the invention. Therefore, the appended claims are intended to more fully encompass the full scope of the present invention.

I claim:

1. A drawstring trash bag comprising:
a first panel and a second panel, the first panel and second panel joined along a first side edge, a second side edge, and a bottom edge,
a first drawstring disposed within a first hem in the first panel.
a first drawstring access hole provided in the first panel, the first drawstring access hole having a width and a height, and
the width of the first drawstring access hole being at least two times the height of the first drawstring access hole.

2. The drawstring trash bag of claim 1 further comprising:
the first drawstring is an embossed drawstring.

3. The drawstring trash bag of claim 1 further comprising:
a second drawstring disposed within a second hem in the second panel,
a second drawstring access hole provided in the second panel, the second drawstring access hole having a width and a height, and
the width of the second drawstring access hole being at least two times the height of the second drawstring access hole.

4. The drawstring trash bag of claim 3 further comprising:
the second drawstring is an embossed drawstring.

5. The drawstring trash bag of claim 1, further comprising:
the first drawstring access hole being substantially elliptical.

6. The drawstring trash bag of claim 1, further comprising:
the width of the first drawstring access hole being between two and four times the height of the first drawstring access hole.

7. The drawstring trash bag of claim 6, further comprising:
the width of the first drawstring access hole being approximately three times the height of the first drawstring access hole.

8. The drawstring trash bag of claim 3, further comprising:
the width of the first drawstring access hole being between two and four times the height of the first drawstring access hole.
the width of the second drawstring access hole being between two and four times the height of the second drawstring access hole.

9. The drawstring trash bag of claim 8, further comprising:
the width of the first drawstring access hole being approximately three times the height of the first drawstring access hole.
the width of the second drawstring access hole being approximately three times the height of the second drawstring access hole.

10. A panel for a drawstring trash bag comprising:
a panel of a polymeric material having a first side edge, a second side edge, a top edge, and a bottom edge,
a hem formed in the panel,
a drawstring disposed within the hem,
a drawstring access hole located in the panel wherein the drawstring access hole permits exterior access to the drawstring, the drawstring access hole being located substantially equidistant from the first side edge and the second side edge and the drawstring access hole being located closer to the top edge than the bottom edge, and
a width of the drawstring access hole being at least two times a height of the drawstring access hole.

11. The panel of claim 10, further comprising:
the drawstring is an embossed drawstring.

12. The panel of claim 10, further comprising:
the width of the drawstring access hole being between two and four times the height of the drawstring access hole.

13. The drawstring trash bag of claim 12, further comprising:
the width of the drawstring access hole being approximately three times the height of the drawstring access hole.

14. The drawstring trash bag of claim 10, further comprising:
the drawstring access hole being substantially elliptical.

15. A method for creating a drawstring trash bag comprising the steps of:
providing a first panel and a second panel joined along a first edge, a second edge, and a bottom,
creating a first drawstring access hole in the first panel, wherein a width of the first drawstring access hole is at least two times a height of the first drawstring access hole, and disposing a first drawstring within the first hem wherein the first drawstring is accessible through the first drawstring access hole.

16. The method of claim 15, further comprising the steps of
creating a second drawstring access hole in the second panel, wherein a width of the second drawstring access hole is at least two times a height of the second drawstring access hole, and
disposing a second drawstring within the second hem wherein the second drawstring is accessible through the second drawstring access hole.
